(19) United States
(12) Patent Application Publication
(10) Pub. No.: US 2007/0143918 A1
(43) Pub. Date: Jun. 28, 2007

(54) Rechargeable foot bath

(75) Inventors: Michael Cafaro, El Paso, TX (US); Ruben Enriquez, El Paso, TX (US); Evang Wong, Hong Kong (HK)

Correspondence Address: VINSON & ELKINS, L.L.P., 1001 FANNIN STREET, 2300 FIRST CITY TOWER, HOUSTON, TX, 77002-6760, US

(73) Assignee: Helen of Troy Limited

(21) Appl. No.: 11/518,530

(22) Filed: Sep. 8, 2006

Related U.S. Application Data
(60) Provisional application No. 60/720,363, filed on Sep. 23, 2005.

(51) Int. Cl. A47K 3/022; A61H 35/00; E03C 1/00

(52) U.S. Cl. 4/622

(57) ABSTRACT

A foot spa for treatment of feet includes a fluid reservoir for holding a fluid to cover a user's feet and heating, aeration and massage elements in the reservoir. The foot spa further includes a power supply with rechargeable batteries so the spa can be operated without plugging into an AC power supply or replacing batteries.

### BACKGROUND OF THE INVENTION

Bathing of the feet in hot or warm water has long been practiced for therapeutic reasons as well as for relaxation. Early foot baths were nothing more than a receptacle into which hot water was poured. U.S. Pat. No. 2,736,038 described a foot bath that incorporated an electric heating element that could be plugged into an outlet, thus relieving the inconvenience of having to replenish the hot water by a user or by someone assisting the user.

Since that early patent, foot baths or spas have become much more sophisticated and many features have been added. For example, foot spas have been described that provide vibration, massage, and/or bubbles in addition to heated water. Some spas also include pedicure stations and various rotating attachments for treatment of the feet. In addition, toe touch buttons and remote control have also been described for the convenience of a user.

### SUMMARY

The present disclosure may be described in certain embodiments as a foot massager provided in the form of a foot bath equipped with a rechargeable battery pack that allows the appliance to be operated with or without an AC power cord adaptor. The foot bath is adapted for accepting and containing bathing water and is shaped and arranged to accommodate two human feet within the bathing water. The foot bath includes a toe touch switch that provides a variety of settings, including heat, massage, and aeration. The base of the foot bath is also provided with a pair of movable massaging elements that perform a massaging function on the feet.

Throughout this disclosure, unless the context dictates otherwise, the word “comprise” or variations such as “comprises” or “comprising,” is understood to mean “includes, but is not limited to” such that other elements that are not explicitly mentioned may also be included. Further, unless the context dictates otherwise, use of the term “a” may mean a singular object or element, or it may mean a plurality, or one or more of such objects or elements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a perspective drawing of an embodiment of a rechargeable foot bath.

FIG. 2 is a top view of the rechargeable foot bath.

FIG. 3 is an electrical circuit diagram for the rechargeable foot bath.

### DETAILED DESCRIPTION

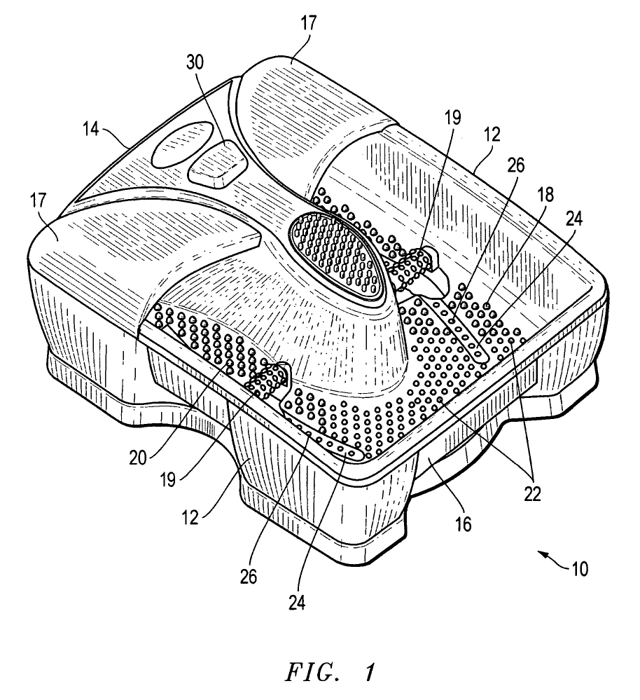

Turning to the drawings, an embodiment of a foot bath 10 is shown in FIG. 1. The foot bath provides various features for the comfort or therapy of a user, and is novel in that the foot bath is completely portable, being powered by rechargeable batteries so that the foot bath can be used without being constrained by the need for an electrical outlet.

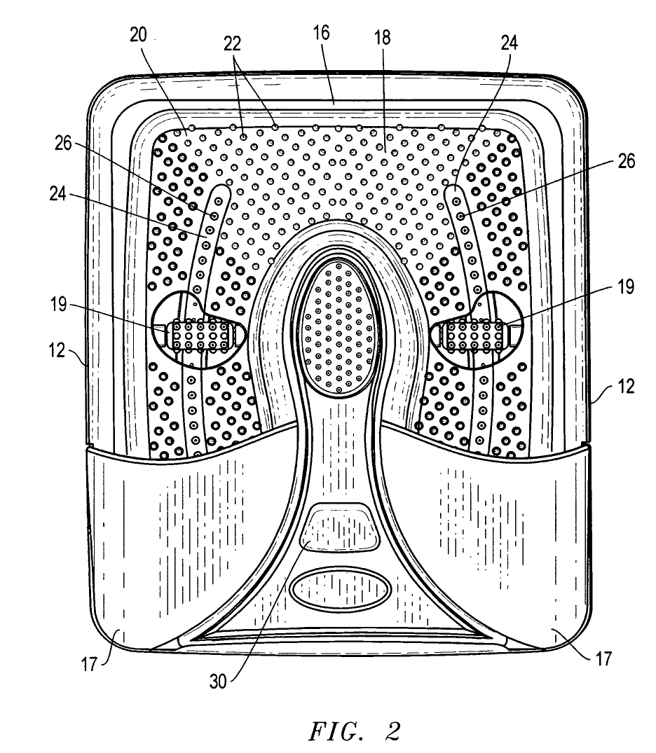

The foot spa 10 includes a housing having side walls 12, a front wall 14, a rear wall 16 and a bottom 18. The housing forms a fluid reservoir 20 that is shaped to accommodate two human feet. The housing also include covers 17 that are removable to aid placing the feet in the reservoir and can be closed to prevent splashing of water out of the reservoir during use. Various features of the foot spa are also shown in FIGS. 1 and 2. The bottom of the reservoir provides small projections 22 such as knobs or nodules extending from the bottom of the housing to stimulate the bottom of the feet of a user. The bottom also provides the moveable massaging elements. The reservoir includes bubble tracks 24 that include openings 26 to release air into the reservoir. The bubble tracks shown are in an arc shape, but other shapes can also be used that might provide various levels of stimulation to certain parts of a user's feet or to provide a larger or smaller area for aeration. When the reservoir is filled with fluid, the bubbling action provides further stimulation to the feet of a user. The foot spa also provides a heating element under the bottom of the reservoir. The heater can include a heating coil or wire that runs under the bottom in a serpentine or other configuration to provide heat to the user's feet and to the fluid in the reservoir.

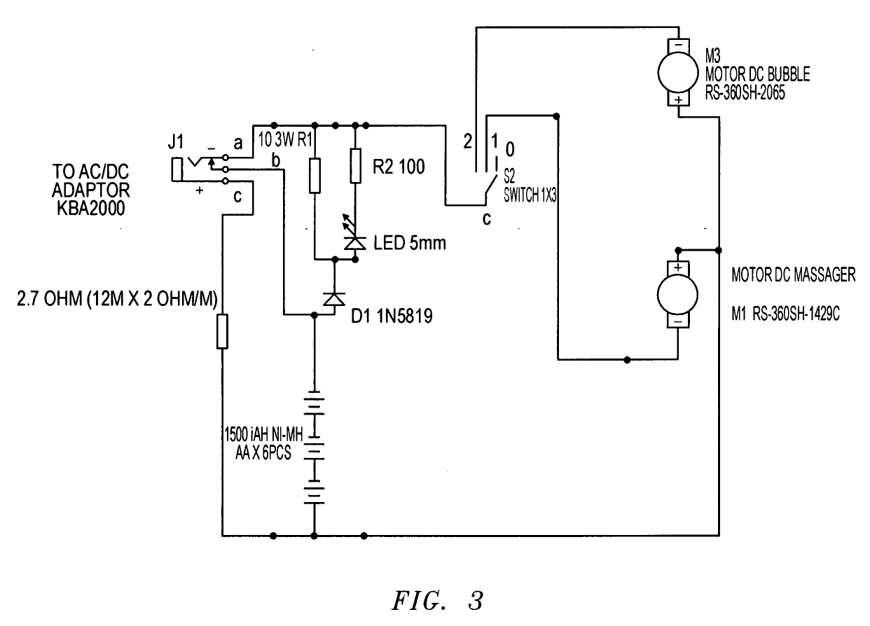

A toe touch button 30 is provided on the foot rest for ease of use. The toe touch button provides various settings including heat, massage, and aeration. A circuit diagram of an electrical circuit contained in the housing of the foot bath is shown in FIG. 3. The toe touch button is connected to 3 one way switches. One switch controls a DC motor connected to the aeration system that forces air through the bubble tracks to create the bubble effect. A second switch controls a DC motor that is connected to the massage elements. A third switch is connected to a lead wire leading to the heater element. Also shown in the circuit are three rechargeable NiMH batteries that provide power to the system. The foot spa includes a cord with an AC to DC converter to provide power to recharge the batteries.

1. A foot spa comprising:
a housing that forms a reservoir for holding liquid, the reservoir formed by side walls, a front wall, a back wall and a floor, and configured to accommodate two human feet;
a heater element disposed under the reservoir and effective to heat fluid held in the reservoir when activated;
a power supply including a plurality of rechargeable batteries electrically connected to the heater element; and
an AC power cord electrically connected to the rechargeable batteries effective to recharge the batteries when plugged into an AC power source.

2. The foot spa of claim 1, further comprising an aeration system comprising a pump connected to the power supply and one or more air channels connected to air outlets in the reservoir configured to produce a bubbling effect in fluid held in the reservoir when activated.

3. The foot spa of claim 1 further comprising one or more moveable massaging elements attached to the floor of the reservoir.

4. The foot spa of claim 3, wherein the massaging elements are motorized.

5. The foot spa of claim 1, wherein the power supply includes three batteries.

6. The foot spa of claim 5, wherein the batteries are NiMH batteries.

7. The foot spa of claim 1, comprising a toe touch button to control the electrical elements of the foot spa.

8. A foot spa comprising:
a housing that forms a reservoir for holding liquid, the reservoir formed by side walls, a front wall, a back wall and a floor, and configured to accommodate two human feet;
a heater element disposed under the reservoir and effective to heat fluid held in the reservoir when activated;
a power supply including a plurality of rechargeable batteries electrically connected to the heater element;
an AC power cord electrically connected to the rechargeable batteries effective to recharge the batteries when plugged into an AC power source;
an aeration system comprising a pump connected to the power supply and one or more air channels connected to air outlets in the reservoir configured to produce a bubbling effect in fluid held in the reservoir when activated;
one or more motorized moveable massaging elements attached to the floor of the reservoir; and
a toe touch button comprising three switches, including a switch connected to a DC motor to control the aeration system, a switch connected to a DC motor to control the massaging elements and a switch connected to a lead wire leading to the heater element.
